(19) United States
(12) Patent Application Publication
(10) Pub. No.: US 2019/0384801 A1
(43) Pub. Date: Dec. 19, 2019

(54) APPLICATION PROCESSING METHOD, COMPUTER DEVICE, AND STORAGE MEDIUM

(71) Applicant: Tencent Technology (Shenzhen) Company Limited, Shenzhen (CN)

(72) Inventors: Pei LI, Shenzhen (CN); Guoheng Fan, Shenzhen (CN); Jiawen Xie, Shenzhen (CN)

(73) Assignee: Tencent Technology (Shenzhen) Company Limited, Shenzhen (CN)

(21) Appl. No.: 16/555,097

(22) Filed: Aug. 29, 2019

Related U.S. Application Data
(63) Continuation of application No. PCT/CN2018/080502, filed on Mar. 26, 2018.

(30) Foreign Application Priority Data
Mar. 31, 2017 (CN) 201710210788.2

(51) Int. Cl. G06F 16/9537; G06F 3/0481; G06F 3/0482; G06F 9/445; G06F 9/451; G06F 16/29

(52) U.S. Cl. CPC G06F 16/9537; G06F 3/04817; G06F 3/0482; G06F 8/61; G06F 9/451; G06F 16/29; G06F 9/44526

(57) ABSTRACT

An application processing method is disclosed, including: obtaining a target geographical location; querying for found child application identification information that meets a geographical location proximity condition between associated geographical locations and the target geographical location; selecting selected child application identification information from the found child application identification information; and running a child application corresponding to the selected child application identification information in an environment provided by a mother application for running child applications.

### RELATED APPLICATION

This application is a continuation of PTC application Number PCT/CN2018/080502, entitled “APPLICATION PROGRAM PROCESSING METHOD, COMPUTER DEVICE AND STORAGE MEDIUM” filed Mar. 26, 2018, which claims priority to Chinese Patent Application Number 2017102107882, entitled “APPLICATION PROCESSING METHOD AND APPARATUS, AND COMPUTER DEVICE” filed with the China National Intellectual Property Administration on Mar. 31, 2017, both of which are incorporated by reference in their entireties.

### FIELD OF THE TECHNOLOGY

This application relates to the field of computer technologies, and in particular, to an application processing method, a computer device, and a storage medium.

### BACKGROUND OF THE DISCLOSURE

With development of computer technologies, there are various types of terminals. Applications may be run on the terminals, and interaction pages may be generated by using the applications to transmit information and interact with users by using the interaction pages, thereby facilitating people's life and work.

Currently, there is an abundance of applications. An application installation package may be found by searching for a name or category of an application in an application store. The application installation package is then decompressed, various files obtained through the decompression are placed in a specified installation directory, the application is registered in an operating system, and an icon of the application is generated, so that subsequently users may click the icon to start and use the application.

Currently, the search, installation, and use of applications need a series of time-consuming steps, which are very complex, causing relatively low use efficiency of the applications.

### SUMMARY

According to embodiments provided in this application, an application processing method, a computer device, and a storage medium are provided.

In various embodiments, the application processing method includes:

obtaining, by a computer device, a target geographical location;

querying, by the computer device, child application identification information that meets a geographical location proximity condition between associated geographical locations and the target geographical location;

selecting, by the computer device, child application identification information from the found child application identification information; and

running, by the computer device, a child application corresponding to the selected child application identification information in an environment provided by a mother application for running child applications.

The computer device may include a memory and one or more processors. The memory may store computer readable instructions that, when executed by the one or more processors, cause the one or more processors to perform the following steps:

obtaining a target geographical location;

querying child application identification information that meets a geographical location proximity condition between associated geographical locations and the target geographical location;

selecting child application identification information from the found child application identification information; and

running a child application corresponding to the selected child application identification information in an environment provided by a mother application for running child applications.

One or more non-volatile computer readable storage mediums may store computer readable instructions. The computer readable instructions, when executed by one or more processors, may cause the one or more processors to perform the following steps:

obtaining a target geographical location;

querying child application identification information that meets a geographical location proximity condition between associated geographical locations and the target geographical location;

selecting child application identification information from the found child application identification information; and

running a child application corresponding to the selected child application identification information in an environment provided by a mother application for running child applications.

The details of one or more embodiments of this application are disclosed in the following accompanying drawings and description. Other features, objectives, and advantages of this application become clearer from the specification, the accompanying drawings, and the claims.

### BRIEF DESCRIPTION OF THE DRAWINGS

To describe the technical solutions in the embodiments of this application more clearly, the following briefly describes the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a diagram of an application environment of an application processing method according to an embodiment.

FIG. 2 is a schematic diagram of an internal structure of a computer device according to an embodiment.

FIG. 3 is a schematic flowchart of an application processing method according to an embodiment.

FIG. 4 is a schematic diagram of relationships between an operating system, a mother application, a child application, and a child application page according to an embodiment.

FIG. 5 is a schematic flowchart of a step of selecting child application identification information from found child application identification information according to an embodiment.

FIG. 6 is a schematic flowchart of a step of selecting child application identification information from found child application identification information according to another embodiment.

FIG. 7 is a schematic flowchart of a step of sorting found child application identification information according to geographical distances between associated geographical locations and a target geographical location according to an embodiment.

FIG. 8 is a schematic flowchart of a step of running a child application corresponding to selected child application identification information in an environment provided by a mother application for running child applications according to an embodiment.

FIG. 9 is a schematic diagram of a child application search page in an application scenario.

FIG. 10 is a schematic diagram of a child application page of a merchant store child application in an application scenario.

FIG. 11 is a schematic diagram of a store child application information confirmation page in an application scenario.

FIG. 12 is a schematic diagram of a store child application creation result page in an application scenario.

FIG. 13 is a schematic diagram of a login page provided by a merchant store child application in an application scenario.

FIG. 14 is a schematic diagram of a store child application management page in an application scenario.

FIG. 15 is a first schematic diagram of a web page provided by an open service platform in an application scenario.

FIG. 16 is a second schematic diagram of a web page provided by an open service platform in an application scenario.

FIG. 17 is a third schematic diagram of a web page provided by an open service platform in an application scenario.

FIG. 18 is a schematic diagram of a child application search page in an application scenario.

FIG. 19 is a schematic diagram of a merchant list in an application scenario.

FIG. 20 is a schematic diagram of a child application list in an application scenario.

FIG. 21 is a schematic diagram of a child application page generated by using a template in an application scenario.

FIG. 22 is a schematic diagram of a self-developing child application page in an application scenario.

FIG. 23 is a structural block diagram of an application processing apparatus according to an embodiment.

### DESCRIPTION OF EMBODIMENTS

To make the objectives, the technical solutions, and the advantages of this application clearer, the following further describes this application in detail with reference to the accompanying drawings and the embodiments. It should be understood that the specific embodiments described herein are merely used to explain this application, and this application is not limited to those specific embodiments.

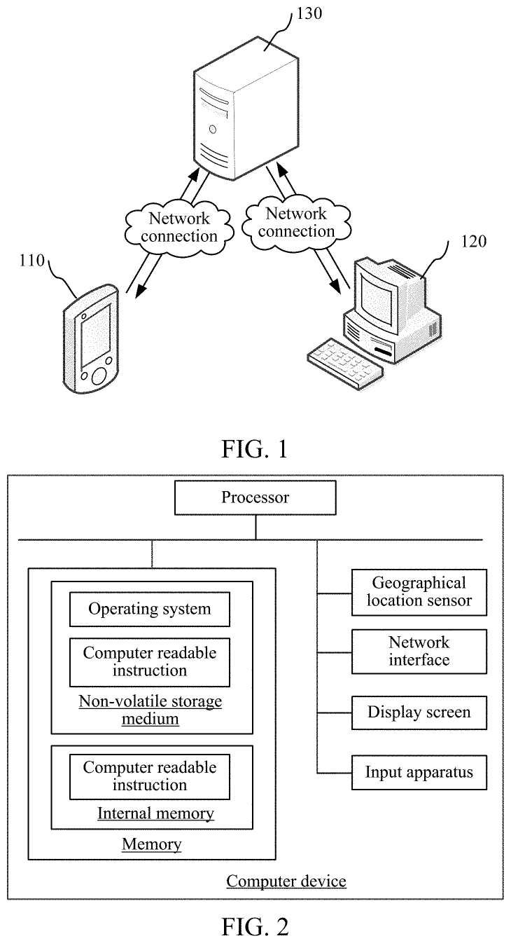

FIG. 1 is a diagram of an application environment of an application processing method according to various embodiments. Referring to FIG. 1, the application environment of the application processing method includes a user terminal 110, a serving party terminal 120, and a server 130. The user terminal 110 is a terminal used by a user of a child application. A serving party is an object providing a service by using a child application, such as a merchant providing a commercial service or a service provider providing a public service. The server 130 may be an independent physical server, or may be a server cluster formed by a plurality of physical servers. The server 130 may include an open service platform, or may include an access server accessed to an open service platform. The user terminal 110 and the serving party terminal 120 may be the same or different terminals. The terminal may be a mobile terminal or a desktop computer, and the mobile terminal may include at least one of a mobile phone, a tablet computer, a person digital assistant, and a wearable device.

FIG. 2 is a schematic diagram of an internal structure of a computer device according to various embodiments. The computer device may be the user terminal 110, the serving party terminal 120, or the server 130 in FIG. 1. Referring to FIG. 2, the computer device includes a processor, a memory, a network interface, a display screen, an input apparatus, and a geographical location sensor connected by using a system bus. The memory includes a non-volatile storage medium and an internal memory. The non-volatile storage medium of the computer device may store an operating system and computer readable instructions, and the computer readable instructions, when executed, cause the processor to perform an application processing method. The processor of the computer device is configured to provide computing and control capabilities to support running of the entire computer device. The internal memory may store computer readable instructions, and the computer readable instructions, when executed by the processor, cause the processor to perform an application processing method. The network interface of the computer device is configured to perform network communications, such as sending a target geographical location, receiving child application identification information found according to the target geographical location, and the like. The display screen of the computer device may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, mouse or the like. The touch layer and the display screen constitute a touch-control screen. The geographical location sensor may be a global positioning system (GPS) sensor.

A person skilled in the art may understand that the structure shown in FIG. 2 is merely a block diagram of the structure of a part related to the solution of this application, and does not constitute a limitation to the computer device to which the solution of this application is applied. Specifically, the computer device may include more components or fewer components than those shown in the figure, some components may be combined, or a different component arrangements may be used.

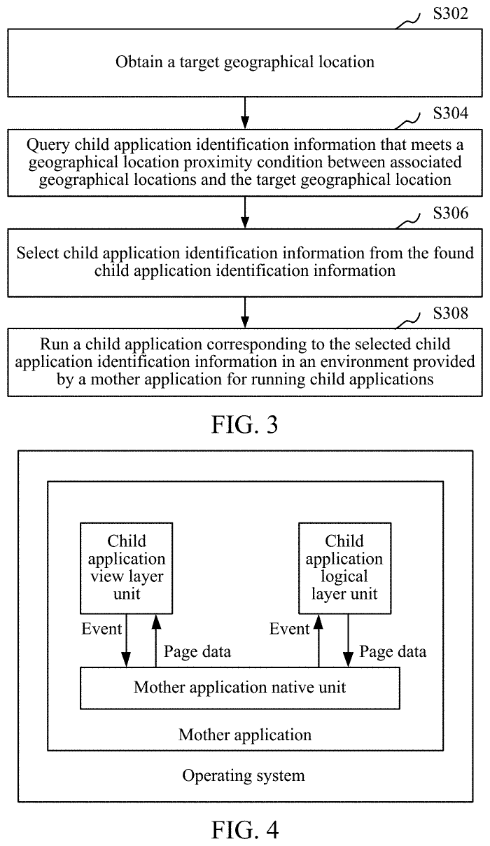

FIG. 3 is a schematic flowchart of an application processing method according to an embodiment. This embodiment is mainly described by using an example in which the method is applied to the user terminal 110 in FIG. 1. Referring to FIG. 3, the method may include the following steps:

S302. Obtain a target geographical location.

The target geographical location is a geographical location used as a basis for searching for a child application. The target geographical location may be represented by longitude and latitude. The user terminal may obtain the target geographical location by using a mother application

Referring to FIG. 4, an operating system is run on the user terminal, and a mother application is run on the operating system. The mother application provides an environment for running of a child application. The user terminal may create, according to a program package of the child application, a child application logical layer unit and a corresponding child application view layer unit for implementing the child application. The child application logical layer unit may be configured to execute page logic code in the program package, and the child application view layer unit may be configured to execute page structure code in the program package, and may further execute page style code in the program package. The page logic code, the page structure code, and the page style code in the program package may be collectively referred to as page code.

The operating system (OS) is a computer program for managing and controlling terminal hardware and software resources, and is system software directly running on a terminal bare computer. The application typically is run under the support of the operating system. The operating system may be a desktop operating system such as a Windows operating system, a Linux operating system, or an Apple desktop operating system (Mac OS), or may be a mobile operating system such as an Apple mobile terminal operating system (iOS) or an Android operating system.

The mother application is an application bearing a child application, and provides an environment for implementation of the child application. The mother application may be a native application. The native application may be an application that may be directly run in the operating system. The mother application may be a social application, a dedicated application for specifically supporting a child application, a file management application, a mail application, a game application, or the like. The social application includes an instant messaging application, a social network service (SNS) application, a live broadcast application, or the like. The child application is an application that may be implemented in an environment provided by the mother application. The child application may be, for example, a social application, a file management application, a mail application, a game application, or the like. The mother application may be, for example, a WeChat program, and the corresponding child application may be referred to as a mini program.

The child application logical layer unit and the corresponding child application view layer unit are configured to implement child application instances. One child application may be implemented by one child application logical layer unit and at least one child application view layer unit. The child application view layer unit and the child application page may be in a one-to-one correspondence.

The child application view layer unit is configured to organize and render views of the child application. The child application logical layer unit is configured to process the child application and a data processing logic of a corresponding child application page. The unit may be specifically a progress or a thread. The child application view layer unit may be a child application view layer thread, and the child application logical layer unit may be a child application logical layer thread. The child application logical layer unit may be run in a virtual machine. The child application view layer unit and the child application logical layer unit may transfer communications by using a mother application native unit. The mother application native unit is an interface for communications between the mother application and the child application, and the mother application native unit may be a thread or progress of the mother application. The page logic code that is of the child application pages and that falls within the program package may be registered when the child application logical layer unit is started, and the registered page logic code is executed when the page logic code is needed to process data.

S304. Query child application identification information that meets a geographical location proximity condition between associated geographical locations and the target geographical location.

The child application identification information is used for identifying a corresponding child application, and may include a unique identifier (AppID) of the child application, or may include serving party information. Each piece of child application identification information may be associated with a unique geographical location, or may be associated with more than one geographical location. That is, one child application may be associated with a plurality of geographical locations. For example, the serving party may generate only one child application, and associate a plurality of locations for the child application, to query the same child application at different target geographical locations.

The serving party information may be a serving party icon, a serving party name, or serving party location information. The serving party icon may be a merchant avatar, the serving party name may be a merchant register name or an abbreviation of a register name, and the serving party location information may be a merchant address.

The geographical location proximity condition refers to a condition to which geographical locations determined to be close should conform. If found child application identification information corresponds to a geographical location, and the geographical location and a target geographical location meet the geographical location proximity condition, a child application corresponding to the child application identification information may be referred to as a nearby child application of the target geographical location.

In an embodiment, a user terminal may report a target geographical location to a server, and receive child application identification information fed back by the server, and a geographical location associated with the child application identification information and the target geographical location meet the geographical location proximity condition.

After receiving the target geographical location, the server may traverse the child application identification information, determine whether a geographical location corresponding to the traversed child application identification information and the target geographical location meet the geographical location proximity condition, to thereby find child application identification information corresponding to the geographical location that meets the geographical location proximity condition, and return the child application identification information to the user terminal.

S306. Select child application identification information from the found child application identification information.

Specifically, the user terminal may select some or all child application identification information from the found child application identification information.

In an embodiment, the user terminal may automatically select the child application identification information from the found child application identification information according to a pre-configured selection method. The pre-configured selection method is selecting child application identification information in the closest distance, or selecting child application identification information having the highest page views.

In an embodiment, the user terminal may also display the found child application identification information, to select, according to a received selection instruction, child application identification information specified by the selection instruction from the displayed child application identification information. The selection instruction may be triggered by a user by using an input apparatus of the user terminal.

S308. Run a child application corresponding to the selected child application identification information in an environment provided by a mother application for running child applications.

In an embodiment, the user terminal may create a child application logical layer unit and a corresponding child application view layer unit by using a mother application; and load, by using the child application logical layer unit, a program package corresponding to the selected child application identification information, and instruct the child application view layer unit to complete rendering of the child application page.

An environment in which the child application logical layer unit and the corresponding child application view layer unit created by the mother application run is an environment in which the child application corresponding to the selected child application identification information runs.

In the foregoing application processing method, after the target geographical location is obtained, child application identification information whose associated geographical location is close to the target geographical location may be found, the child application identification information is selected therefrom, and a corresponding child application is run in the environment provided by the mother application. Therefore, the needed child application may be determined by using the geographical location. This is convenient and fast; and the child application is run in the environment provided by the mother application for running the child application, without the need of a complex installation process, thereby improving the application use efficiency.

In an embodiment, step S302 includes: obtaining a current geographical location as a target geographical location. The current geographical location may be obtained through sensing by using the geographical location sensor of the user terminal, or may be calculated by using a network locating method. The network locating method may be specifically an Internet Protocol (IP) address locating method or a base station locating method.

In this embodiment, the current geographical location is automatically obtained as the target geographical location, so that the target geographical location may be obtained efficiently.

In an embodiment, step S302 includes: obtaining a character input in a search box, and obtaining, according to the input character, the target geographical location obtained by analyzing the input character.

Specifically, the user terminal may provide a search box by using the mother application, and the user terminal may obtain the character input in the search box, send the character to the server, and receive a target geographical location that is obtained by analyzing the input character and that is fed back by the server. The user terminal may also locally analyze the input character, to obtain the corresponding target geographical location.

The analyzing the input character may be specifically calculating a similarity between the input character and a preset address template, and finding a largest address template whose similarity is higher than a preset similarity, to obtain a preset geographical location corresponding to the address template, as the target geographical location.

In this embodiment, the user may input a character to determine a target geographical location, so that the user may query a child application associated with any geographical location that the user intends to go, or may provide an additional method for obtaining the target geographical location when the current geographical location cannot be automatically obtained.

In an embodiment, step S302 includes: obtaining a geographical location associated with local child application identification information as a target geographical location. The local child application identification information may be child application identification information corresponding to a child application that is used or being used.

In this embodiment, the associated target geographical location may be determined by using known child application identification information, so that the child application may be found by using the child application, thereby providing a new method for searching for the child application efficiently.

In an embodiment, the method for obtaining a current geographical location as the target geographical location, the method for obtaining a character input in a search box, and obtaining, according to the input character, the target geographical location obtained by analyzing the input character, and the method for obtaining a geographical location associated with local child application identification information as the target geographical location may be all provided by the mother application.

In an embodiment, the geographical location proximity condition includes: geographical locations associated with the found child application identification information fall within a geographical region range to which the target geographical location belongs.

The geographical region range to which the target geographical location belongs may be a circular region, an elliptic region, a rectangular region or the like centered on the target geographical location. In this embodiment, the geographical region range to which the target geographical location belongs may be first determined, to further find the child application identification information whose associated geographical location is within the geographical region range.

In an embodiment, the target geographical location falls within a geographical region range to which the geographical locations associated with the found child application identification information belong.

The geographical region range to which the geographical locations associated with the child application identification information belong may be a circular region, an elliptic region, a rectangular region, or the like centered on the geographical location. In this embodiment, a geographical region range to which the geographical locations associated with all child application identification information belong may be first determined, to further determine whether the target geographical location falls within the geographical region range to which the geographical locations associated with all the child application identification information belong, to query the child application identification information.

In an embodiment, the geographical region range to which geographical locations associated with the found child application identification information belong and the geographical region range to which the target geographical location belongs have an intersection. The intersection may be joint or tangent.

In the foregoing embodiment, the child application identification information that meets the geographical location proximity condition may be found precisely by using a plurality of methods, to further precisely locate and run the needed child application by using a precise geographical location.

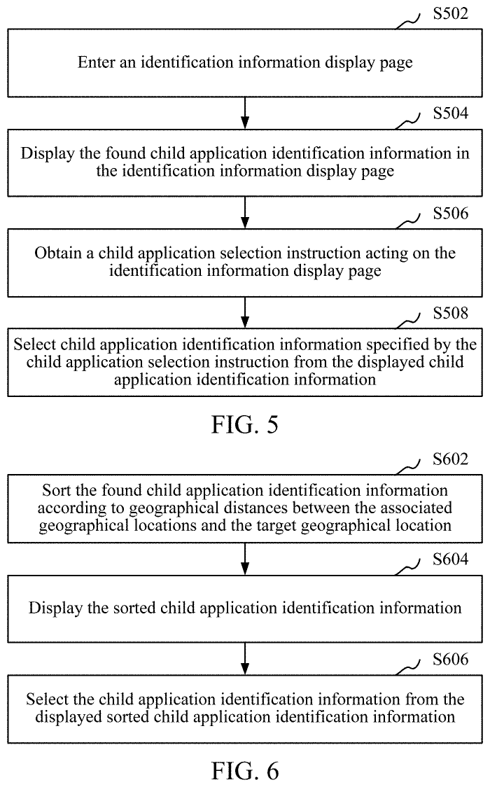

Referring to FIG. 5, in an embodiment, step S306 includes the following steps:

S502. Enter an identification information display page.

The identification information display page is a page used for displaying child application identification information. The user terminal may display an entry of the identification information display page, and perform step S502 when detecting a trigger operation for the entry. The entry may be displayed in a child application search page. The entry may be referred to as a nearby entry.

S504. Display the found child application identification information in the identification information display page.

Specifically, the user terminal may display the found child application identification information by items in the identification information display page. Each item corresponds to one child application.

S506. Obtain a child application selection instruction acting on the identification information display page.

Specifically, the user terminal may detect a selection operation acting on the identification information display page, and trigger a corresponding selection instruction. The selection operation is an operation used for selecting the displayed child application identification information in the identification information display page. The selection operation may be, for example, a touch operation, a physical button operation, a terminal posture change operation, or the like.

S508. Select child application identification information specified by the child application selection instruction from the displayed child application identification information.

Specifically, the user terminal may obtain an event triggered by the selection instruction, and the event carries location coordinates of the display screen, to select the child application identification information from the displayed child application identification information according to the location coordinates.

In this embodiment, the child application identification information is displayed in the identification information display page for the user to select, so that a child application that needs to be run may be freely selected and run, thereby improving the convenience of using the child application.

In an embodiment, before step S502, the method further includes: displaying an entry used for triggering an identification information display page; displaying icons included in a preset number of pieces of child application identification information in the found child application identification information at the entry, and/or displaying a total number of pieces of the found child application identification information at the entry; and performing step S502 when a trigger operation for the entry is detected.

The entry is an operable component having a display region. The user terminal may display an icon and/or the total number of pieces of the found child application identification information on the display region of the operable component. The icon is included in the found child application identification information.

Each piece of child application identification information corresponds to one child application, and each piece of child application identification information may include a unique icon. The icon is used for representing a corresponding child application. The total number of pieces of the found child application identification information reflects a total number of the corresponding child applications.

The entry may be displayed in a child application search page including a search box. A child application name or a character representing a geographical location may be input in the search box. The child application search page may be further used for displaying recommended child application identification information or a recommended child application category. For example, the preset number may be four. The preset number of pieces of child application identification information may be the previous preset number of pieces of child application identification information selected after the found child application identification information is sorted.

In the foregoing embodiment, the icon and the total number of pieces of the found child application identification information are displayed at the entry, so that the situation of the found child application identification information may be represented visually, and more information amounts may be contained in a page in which the entry is located.

As shown in FIG. 6, in an embodiment, step S306 specifically includes the following steps:

S602. Sort the found child application identification information according to geographical distances between the associated geographical locations and the target geographical location.

Specifically, the user terminal may sort the found child application identification information according to a descending order or an ascending order of the geographical distances between the associated geographical locations and the target geographical location, or by combining the geographical distances with other elements.

S604. Display the sorted child application identification information.

Specifically, the user terminal may enter a child application identification information display page, and display the sorted child application identification information on the child application identification information display page.

S606. Select the child application identification information from the displayed sorted child application identification information.

Specifically, the user terminal may obtain a selection instruction, to select, from the displayed sorted child application identification information, child application identification information specified by the selection instruction. The user terminal may specifically obtain a child application selection instruction acting on the identification information display page, and select, from the displayed child application identification information, the child application identification information specified by the child application selection instruction.

In the foregoing embodiment, the found child application identification information is sorted according to the geographical distances, so that a relationship between the found child application identification information and the target geographical location may be reflected more visually, to facilitate selection and running of the child application conveniently.

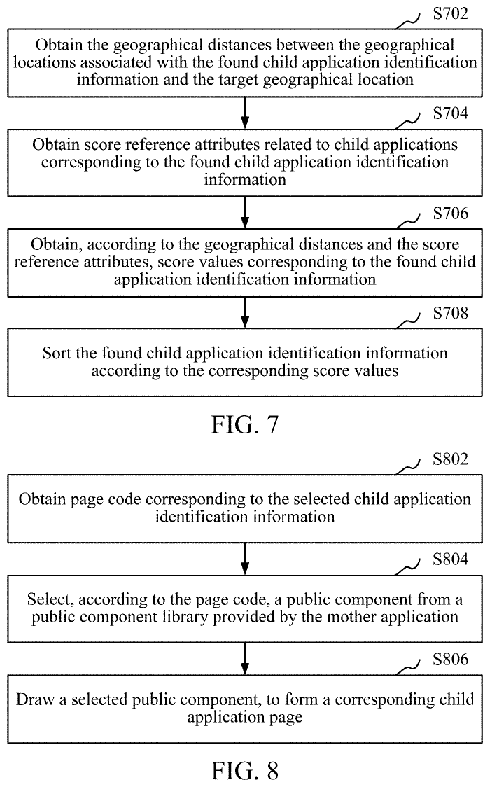

As shown in FIG. 7, in an embodiment, step S602 specifically includes the following steps:

S702. Obtain the geographical distances between the geographical locations associated with the found child application identification information and the target geographical location.

The geographical distances are data representing distances between different locations in the real world. The geographical distances between the geographical locations may be real distances between the corresponding geographical locations, or may be values in a positive correlation with the real distances. The positive correlation may be proportional.

When the geographical location proximity condition is that geographical locations associated with the found child application identification information fall within a geographical region range to which the target geographical location belongs, and is specifically that the geographical distances between the geographical locations associated with the found child application identification information and the target geographical location are less than or equal to a preset value, the geographical location obtained in step S702 may be the geographical distance obtained during the query.

S704. Obtain score reference attributes related to child applications corresponding to the found child application identification information.

The score reference attributes are attributes scored in combination with the geographical distance. The score reference attributes may include a score reference attribute used for positive weighting and a score reference attribute used for negative weighting. The positive weighting is a processing process of enlarging a score value, and the negative weighting is a processing process of reducing a score value. The score reference attributes may include an attribute of a corresponding child application, or may include a user attribute related to a corresponding child application, or may include a serving party attribute of a corresponding child application.

In an embodiment, the score reference attributes include one of or a combination of more of the following: access statistics of a corresponding child application, a child application category, access statistics of a corresponding function component, use statistics of a corresponding function component, a related user attribute, a related user relationship link attribute, a related user feedback quantization value, related time information, and a grading level of a geographical region range to which the associated geographical locations belong.

The access statistics are, for example, a click-through rate, a share rate, an old user usage rate, code scans, page views at a time period, or unique visitors at a time period of a corresponding child application.

The click-through rate may be represented as the number of times of accesses by entering a corresponding child application through a nearby entry in the number of times of displaying corresponding child application identification information through the nearby entry.

The share rate may be represented as the proportion of the number of user share times in the number of access times by entering a corresponding child application through a nearby entry.

The old user usage rate may be represented as the proportion of the number of times that old users access a corresponding child application in a total number of access times. The old user may be defined as a user accessing the same child application again in a preset number of latest days.

The code scans may be represented as the number of times of entering a corresponding child application by scanning barcode. The bar code may be QR code or bar code.

The child application category is used for representing a set of child applications having the same or similar feature. Different child application categories may be endowed with different weights. The child application category whose page views within a time period exceed a preset threshold may be endowed with higher weights than other child application categories. The weight represents the impact on the score value. The child application category whose page views exceed a preset threshold may be obtained by analyzing big data of a plurality of users, or may be obtained by recording and analyzing personal behaviors of current users of the user terminal.

The function component may be a public component or a plug-in included in the corresponding child application. The access statistics of the function component are, for example, the number of accessed function components. The use statistics of the corresponding function component are, for example, the number of used times of the accessed function component.

The related user attribute is, for example, an attribute of a current user of the user terminal. The related user relationship link attribute is, for example, an attribute of a user having a user relationship link with the current user of the user terminal. The user attribute is, for example, age, gender, a user behavior record, or a user portrait label.

The time information is, for example, whether the exposure in the preset number of latest days is less than a preset value, or different time periods may correspond to different weights, or a child application created within latest preset duration may be endowed with higher weights than the child application created before the latest preset duration.

The user feedback quantization value is, for example, a user estimation value, user complaints, a user complaint processing amount, or a user complaint processing rate. The grading level of the geographical region range to which the associated geographical locations belong is, for example, a grading level of a popular business area. Different grading levels may be respectively endowed with different weights.

S706. Obtain, according to the geographical distances and the score reference attributes, score values corresponding to the found child application identification information.

Specifically, the user terminal may perform weighted summation on the geographical distances corresponding to the found child application identification information and the corresponding score reference attributes, to obtain score values respectively corresponding to the found child application identification information. The user terminal may further process the value obtained through the weighted summation, to obtain the score values. The score values are in a positive correlation with the value obtained through the weighted summation.

In an embodiment, the server may obtain the geographical distances between the geographical locations associated with the found child application identification information and the target geographical location, obtain score reference attributes related to child applications corresponding to the found child application identification information, and obtain, according to the geographical distances and the score reference attributes, score values respectively corresponding to the found child application identification information, to return the score values to the user terminal.

S708. Sort the found child application identification information according to the corresponding score values.

Specifically, the user terminal may sort the found child application identification information according to a descending order or an ascending order of the corresponding score values.

In the foregoing embodiment, the found child application identification information is scored with reference to the geographical distances and the related score reference attributes, and the child application identification information may be further sorted according to the corresponding score values, so that the user can accurately and efficiently locate and use the needed child application, thereby further improving the child application use efficiency.

In an embodiment, step S306 includes: when a plurality of pieces of the found child application identification information corresponds to the same serving party identification information, displaying the corresponding serving party identification information; obtaining a serving party selection instruction acting on the displayed serving party identification information; displaying child application identification information corresponding to serving party identification information specified by the serving party selection instruction; and selecting child application identification information from the displayed child application identification information.

The child application identification information corresponding to the same serving party identification information represents a plurality of child applications provided by the same serving party. For example, a merchant A opens a plurality of physical stores, and each physical store corresponds to one child application. When child application identification information respectively corresponding to more than one physical store of the merchant A is found, identification information of the merchant A may be directly displayed, and further after the user selects the displayed identification information of the merchant A, found child application identification information corresponding to the identification information of the merchant A is displayed, to further implement selection and running of the child application.

In an embodiment, for found child application identification information corresponding to unique serving party identification information, the unique serving party identification information may be displayed, or the child application identification information corresponding to the unique serving party identification information is directly displayed.

In the foregoing embodiment, the child application identification information corresponding to the same serving party identification information is jointly displayed, so as to visually present a subordination relationship between the child application and the serving party, to efficiently locate the needed child application.

In an embodiment, the geographical locations associated with the child application identification information are entered after log in with a public identifier, and are associated with child application identification information specified by the public identifier.

Specifically, after logging in to the serving party terminal by using the corresponding public identifier, the serving party may enter a child application management page provided by the server. The child application management page may implement entering of the geographical location, or may implement editing and deleting of the existing geographical location. The child application management page may implement association of the child application identification information specified by the public identifier and the geographical location specified by the public identifier. The public identifier is an identifier providing a service to a user by using an open service platform, and the public identifier is, for example, a WeChat public account. Different public identifiers may provide different services. The geographical location may be valid after being audited, and may limit that only the valid geographical location can be associated with the child application identification information.

In the foregoing embodiment, after logging in by using the public identifier, the server may implement entering of the geographical location and association between the geographical location and the child application identification information, and may freely configure a geographical location associated with the child application, to facilitate reuse of the geographical location of the child application.

As shown in FIG. 8, in an embodiment, step S308 specifically includes the following steps:

S802. Obtain page code corresponding to the selected child application identification information.

Specifically, the user terminal may obtain, by using a mother application, a program package corresponding to the child application identification information, and obtain page code from the program package. The page code may include page logic code, page structure code, and page style code. The program package may be read locally, or may be downloaded from the server.

The page structure code is code for defining a page form. The page structure code may include a public component identifier included in the page. The page style code is code for defining a page style. The page logic code is code for defining a processing logic of a corresponding child application page.

S804. Select, according to the page code, a public component from a public component library provided by the mother application.

Specifically, the user terminal may execute page structure code by using the child application view layer unit, and select, from a public component library according to an identifier of a public component defined in the executed page structure code, a public component corresponding to the identifier.

The public component library may be stored locally in the user terminal, and after the child application view layer unit is created, the public component library may be loaded by using the child application view layer unit. The selected public component may be a public component that is needed when the child application page is generated and that is defined in the page structure code.

The public component may be a component shared by different child application pages, may have a visual shape, and may be a formation unit of the child application page. The public component may have a unique identifier, which may be a name of the public component.

In an embodiment, the public component may be an icon, a text container, a progress bar, a form component, a navigation component, a media component, a map component, or a canvas component. The form component may include a button, a selection frame, a form, a switch, and the like.

S806. Draw a selected public component, to form a corresponding child application page.

Specifically, the user terminal may obtain, by using the child application view layer unit, default component style data carried by a selected public component, to organize and render the selected public component according to the default component style data, and form a child application page.

In an embodiment, the user terminal may obtain page style code in a program package of the child application by using the child application view layer unit, and draw a corresponding public component according to the page style code and component style data corresponding to the selected public component, to form the child application page.

In an embodiment, the page code corresponding to the selected child application identification information includes code used for accessing a plug-in. The method further includes: obtaining a corresponding plug-in according to the code used for accessing a plug-in; and step S806 includes: drawing the selected public component and the obtained plug-in, to form the corresponding child application page.

The plug-in may be a function component outside the public component library. The plug-in may be developed by a developer other than a developer of the child application and a developer of the mother application. The plug-in may implement coupon, payment, membership services and the like. The plug-in may interact with an access server corresponding to the plug-in by using the open service platform, to process a logic of the plug-in.

The plug-in is introduced to the child application, so that functions outside the public component library may be expanded for the child application, and development costs of redevelopment may be avoided. The plug-in may be shared by a plurality of child applications, thereby enriching the function of the child application.

In the foregoing embodiment, during running of the mother application, the child application page may be constructed rapidly by using the public component provided by the mother application, thereby shorting the application installation time, and improving the application use efficiency.

In an embodiment, the page code corresponding to the selected child application identification information is generated according to preset child application template code and a serving party attribute corresponding to the selected child application identification information.

Specifically, the server may provide a child application page template, and configure a mapping relationship between information needed in the child application template code and the serving party attribute. After obtaining a command that is for generating a child application and that is triggered by using a public identifier of the serving party, the server may obtain, according to the mapping relationship between the information needed in the child application template code and the serving party attribute, a serving party attribute corresponding to the public identifier, to combine the child application template code and the obtained serving party attribute as the page code of the child application. The serving party attribute is, for example, a serving party name, a serving party contact method, or a serving party icon.

In the foregoing embodiment, the child application may be rapidly generated by using the preset child application template code and the serving party attribute, thereby avoiding the process of developing the child application, and improving the child application implementation efficiency.

The following describes the principle of the foregoing application processing method by using a specific application scenario. In this application scenario, the following processes are specifically implemented:

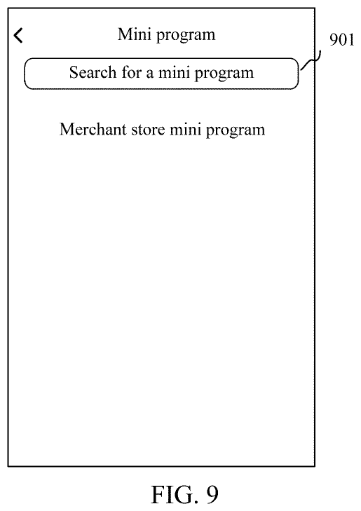

As shown in FIG. 9, a child application search page provided by the mother application is entered. The child application search page includes a search box. The search box may be used for inputting a character to search the child application. A merchant store child application is searched by using the search box. The merchant store child application is used for creating a child application of the store child application. The store child application is a child application associated with a store of a merchant. The store may be a business place opened by the merchant.

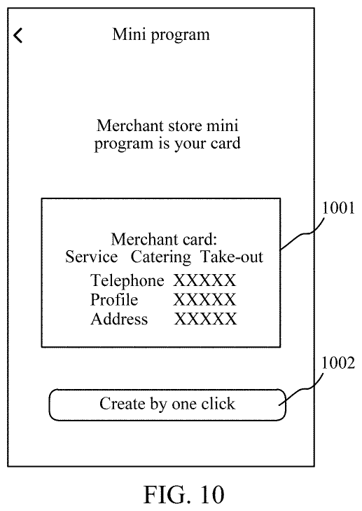

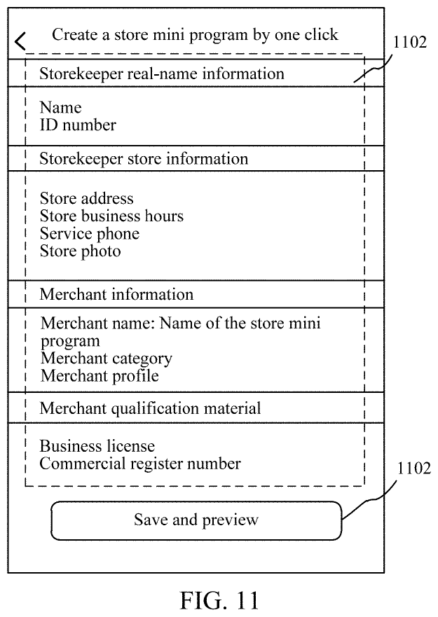

As shown in FIG. 10, after the merchant store child application is run, a child application page provided by the merchant store child application is entered, and merchant identification information, such as, for example, a service range, a telephone number, a merchant profile, and a merchant address, is displayed in the child application page. The page of the merchant store child application may further display a store child application creation button, and after the store child application creation button is clicked, a store child application information confirmation page shown in FIG. 11 is entered.

As shown in FIG. 11, merchant information 1101 needed when the store child application is generated, and a creation confirmation button 1102, may be displayed in the store child application information confirmation page. After the creation confirmation button 1102 is clicked, a store child application creation command is triggered to be sent to a server, so that the server generates a corresponding store child application according to preset child application template code and the merchant information.

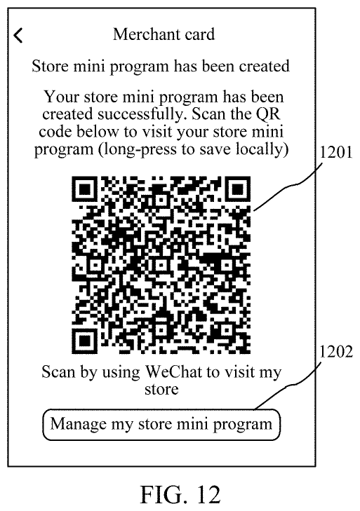

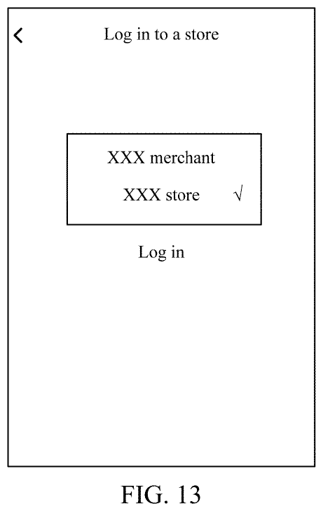

As shown in FIG. 12, the merchant store child application displays a store child application creation result page shown in FIG. 12. The merchant store child application may obtain QR code of the store child application created successfully, and display the QR code in the store child application creation result page. The store child application creation result page may further display a program management button 1202. After the program manage button 1202 is clicked, the merchant store child application enters a login page shown in FIG. 13.

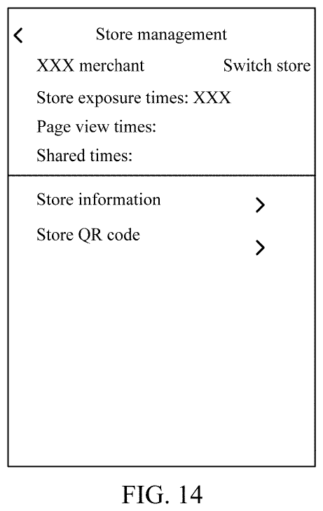

As shown in FIG. 13, after the created store child application is selected in the login page, the merchant store child application enters a store child application management page shown in FIG. 14. The store child application management page may display statistical data of the corresponding store child application, or may browse information and barcode of the store child application.

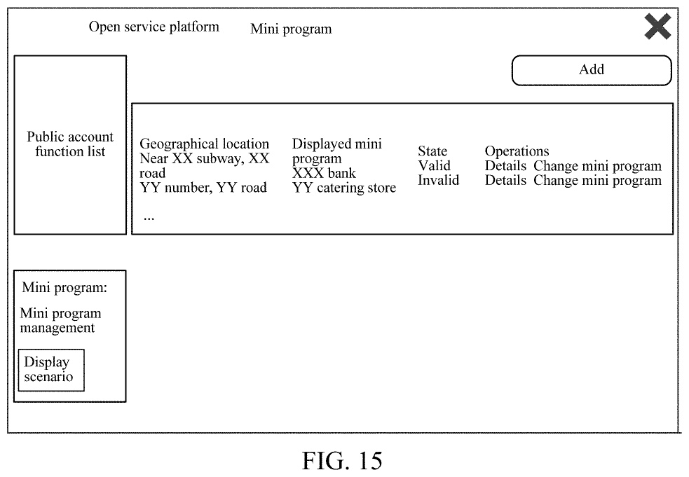

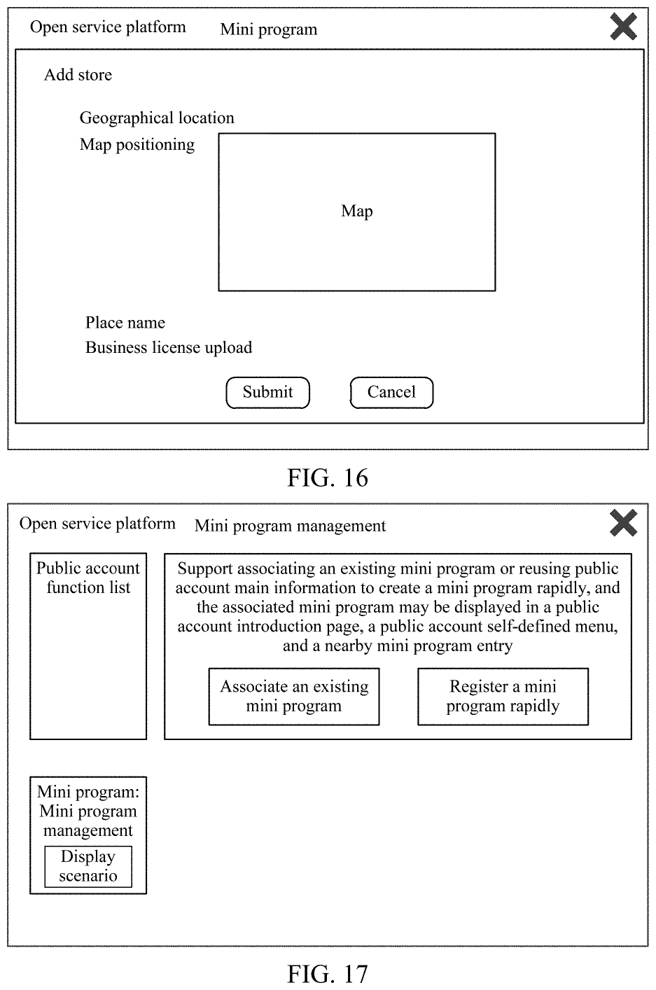

Referring to FIG. 15 to FIG. 17, a merchant may log in, by using a public identifier, to a web page provided by an open service platform, and may enter a geographical location in the web page. Specifically, the merchant may select the geographical location by using a map component provided in the web page, and upload a merchant certificate file, to associate the geographical location to an existing store child application, or associate the geographical location to a store child application created in real time.

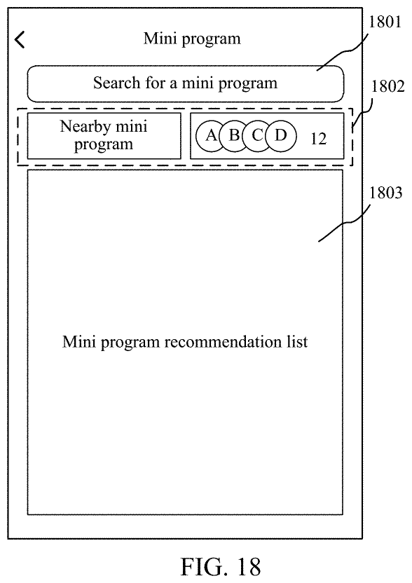

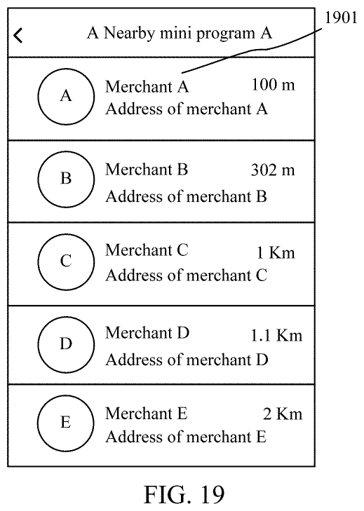

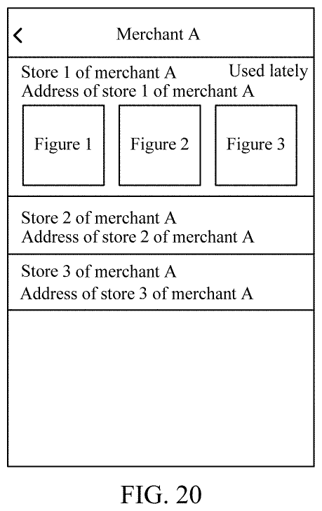

As shown in FIG. 18, the mother application may provide a child application search page shown in FIG. 18, and display a search box 1801, a nearby entry 1802, and a child application recommendation list 1803 in the child application search page. The nearby entry 1802 displays a total number of child applications found according to a current geographical location and icons of four child applications thereof. The four child applications may be child applications whose associated geographical locations are closest to the current geographical location among the found child applications. After the nearby entry 1802 is clicked, the mother application or a dedicated child application may provide a merchant list shown in FIG. 19.

As shown in FIG. 19, the merchant list displays identification information of merchants to which the found child applications belong, such as merchant icons, merchant names, or merchant addresses. Geographical distances between the geographical locations associated with the corresponding child applications and the current geographical location may be further displayed. When the merchant corresponds to a plurality of child applications, a geographical distance between the corresponding closest geographical location and the current geographical location may be displayed. In addition, one store child application may correspond to a plurality of stores, to associate a plurality of geographical locations, so that a user may search the same store child application for different target geographical locations, and make child application identification information of the store child application be consistent with the external performance, to facilitate management of the store child application, and ensure unified use experience.

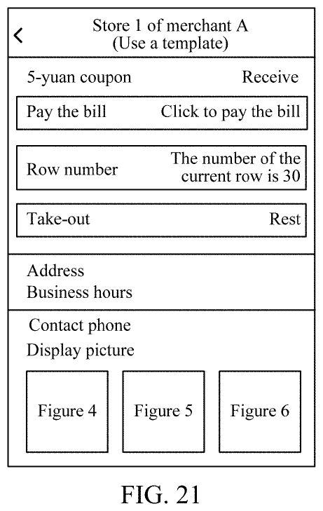

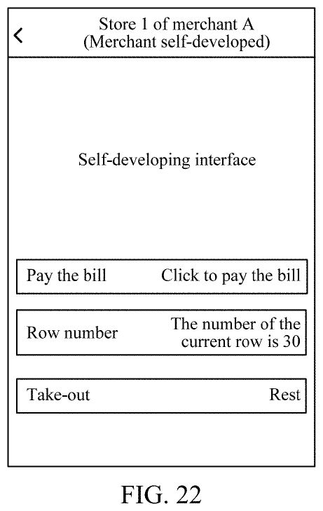

After identification information of a merchant in the merchant list is selected, the mother application or the dedicated child application may provide a child application list shown in FIG. 20. The child application list may display identification information of a store child application corresponding to the selected identification information of the merchant. After identification information of a store child application is selected, the mother application runs the corresponding store child application. The store child application may be generated by using preset child application template code, as shown in FIG. 21; or the store child application may be developed by a merchant by using a child application, as shown in FIG. 22.

In an embodiment, a computer device is further provided. An internal structure of the computer device may be shown in FIG. 2. The computer device includes an application processing apparatus. The application processing apparatus includes modules, and all or a part of each module may be implemented by using software, hardware, or a combination thereof.

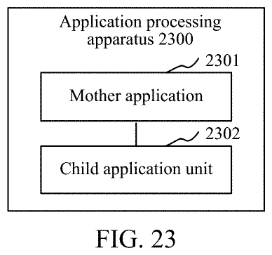

As shown in FIG. 23, in an embodiment, an application processing apparatus 2300 is provided. Referring to FIG. 23, the application processing apparatus 2300 includes a mother application 2301 and a child application unit 2302. The child application unit 2302 may include a child application view layer unit and a child application logical layer unit.

The mother application 2301 is configured to: obtain a target geographical location; query child application identification information that meets a geographical location proximity condition between associated geographical locations and the target geographical location; and select child application identification information from the found child application identification information.

The child application unit 2302 may be configured to run, in an environment provided by the mother application 2301 for running child applications, a child application corresponding to the selected child application identification information.

In an embodiment, the mother application 2301 is further configured to: obtain a current geographical location as the target geographical location; or obtain a character input in a search box, and obtain, according to the input character, the target geographical location obtained by analyzing the input character; or obtain a geographical location associated with local child application identification information as the target geographical location.

In an embodiment, the geographical location proximity condition includes: the geographical locations associated with the found child application identification information fall within a geographical region range to which the target geographical location belongs; or the target geographical location falls within a geographical region range to which the geographical locations associated with the found child application identification information belong; or a geographical region range to which the geographical locations associated with the found child application identification information belong and a geographical region range to which the target geographical location belongs have an intersection.

In an embodiment, the mother application 2301 is further configured to: enter an identification information display page; display the found child application identification information in the identification information display page; obtain a child application selection instruction acting on the identification information display page; and select child application identification information specified by the child application selection instruction from the displayed child application identification information.

In an embodiment, the mother application 2301 is further configured to: display an entry used for triggering the identification information display page; display icons included in a preset number of pieces of child application identification information in the found child application identification information at the entry, and/or display a total number of pieces of the found child application identification information at the entry; and enter an identification information display page when a trigger operation for the entry is detected.

In an embodiment, the mother application 2301 is further configured to sort the found child application identification information according to geographical distances between the associated geographical locations and the target geographical location; display the sorted child application identification information; and select the child application identification information from the displayed sorted child application identification information.

In an embodiment, the mother application 2301 is further configured to obtain the geographical distances between the geographical locations associated with the found child application identification information and the target geographical location; obtain score reference attributes related to child applications corresponding to the found child application identification information; obtain, according to the geographical distances and the score reference attributes, score values corresponding to the found child application identification information; and sort the found child application identification information according to the corresponding score values.

In an embodiment, the score reference attributes include one of or a combination of more of the following: access statistics of a corresponding child application, a child application category, access statistics of a corresponding function component, use statistics of a corresponding function component, a related user attribute, a related user relationship link attribute, a related user feedback quantization value, related time information, and a grading level of a geographical region range to which the associated geographical locations belong.

In an embodiment, the mother application 2301 is further configured to, when a plurality of pieces of the found child application identification information corresponds to the same serving party identification information, display the corresponding serving party identification information; obtain a serving party selection instruction acting on the displayed serving party identification information; display child application identification information corresponding to serving party identification information specified by the serving party selection instruction; and select child application identification information from the displayed child application identification information.

In an embodiment, the geographical locations associated with the child application identification information are entered after log in with a public identifier, and are associated with the child application identification information specified by the public identifier.

In an embodiment, the child application unit 2302 is further configured to: obtain page code corresponding to the selected child application identification information; select, according to the page code, a public component from a public component library provided by the mother application 2301; and draw the selected public component, to form a corresponding child application page.

In an embodiment, the page code corresponding to the selected child application identification information is generated according to preset child application template code and a serving party attribute corresponding to the selected child application identification information.

In an embodiment, the page code corresponding to the selected child application identification information includes code used for accessing a plug-in. The child application unit 2302 is further configured to: obtain a corresponding plug-in according to the code used for accessing a plug-in; and draw the selected public component and the obtained plug-in, to form the corresponding child application page.

After obtaining the target geographical location, the foregoing application processing apparatus 2300 may find child application identification information whose associated geographical location is close to the target geographical location, select the child application identification information therefrom, and run a corresponding child application in the environment provided by the mother application. Therefore, the needed child application may be determined by using the geographical location. This is convenient and fast; and the child application is run in the environment provided by the mother application for running the child application, without the need of a complex installation process, thereby improving the application use efficiency.

In an embodiment, a computer device is provided, including a memory and one or more processors. The memory stores computer readable instructions, and the computer readable instructions, when executed by the one or more processors, may cause the one or more processors to perform the following steps: obtaining a target geographical location; querying child application identification information that meets a geographical location proximity condition between associated geographical locations and the target geographical location; selecting child application identification information from the found child application identification information; and running a child application corresponding to the selected child application identification information in an environment provided by a mother application for running child applications.

In an embodiment, obtaining a target geographical location includes: obtaining a current geographical location as the target geographical location; or obtaining a character input in a search box, and obtaining, according to the input character, the target geographical location obtained by analyzing the input character; or obtaining a geographical location associated with local child application identification information as the target geographical location.

In an embodiment, the geographical location proximity condition includes: the geographical locations associated with the found child application identification information fall within a geographical region range to which the target geographical location belongs; or the target geographical location falls within a geographical region range to which the geographical locations associated with the found child application identification information belong; or a geographical region range to which the geographical locations associated with the found child application identification information belong and a geographical region range to which the target geographical location belongs have an intersection.

In an embodiment, the selecting child application identification information from the found child application identification information includes: entering an identification information display page; displaying the found child application identification information in the identification information display page; obtaining a child application selection instruction acting on the identification information display page; and selecting child application identification information specified by the child application selection instruction from the displayed child application identification information.

In an embodiment, before the entering an identification information display page, the computer readable instructions further cause the processor to perform the following steps: displaying an entry used for triggering the identification information display page; displaying icons included in a preset number of pieces of child application identification information in the found child application identification information at the entry, and/or displaying a total number of pieces of the found child application identification information at the entry; and performing the step of entering an identification information display page, when detecting a trigger operation for the entry.

In an embodiment, selecting child application identification information from the found child application identification information includes: sorting the found child application identification information according to geographical distances between the associated geographical locations and the target geographical location; displaying the sorted child application identification information; and selecting the child application identification information from the displayed sorted child application identification information.

In an embodiment, sorting the found child application identification information according to geographical distances between the associated geographical locations and the target geographical location includes: obtaining the geographical distances between the geographical locations associated with the found child application identification information and the target geographical location; obtaining score reference attributes related to child applications corresponding to the found child application identification information; obtaining, according to the geographical distances and the score reference attributes, score values corresponding to the found child application identification information; and sorting the found child application identification information according to the corresponding score values.

In an embodiment, the score reference attributes include one of or a combination of more of the following: access statistics of a corresponding child application, a child application category, access statistics of a corresponding function component, use statistics of a corresponding function component, a related user attribute, a related user relationship link attribute, a related user feedback quantization value, related time information, and a grading level of a geographical region range to which the associated geographical locations belong.

In an embodiment, selecting child application identification information from the found child application identification information includes: when a plurality of pieces of the found child application identification information corresponds to the same serving party identification information, displaying the corresponding serving party identification information; obtaining a serving party selection instruction acting on the displayed serving party identification information; displaying child application identification information corresponding to serving party identification information specified by the serving party selection instruction; and selecting child application identification information from the displayed child application identification information.

In an embodiment, the geographical locations associated with the child application identification information are entered after log in with a public identifier, and are associated with child application identification information specified by the public identifier.

In an embodiment, running a child application corresponding to the selected child application identification information in an environment provided by a mother application for running child applications includes: obtaining page code corresponding to the selected child application identification information; selecting, according to the page code, a public component from a public component library provided by the mother application; and drawing the selected public component, to form a corresponding child application page.

In an embodiment, the page code corresponding to the selected child application identification information is generated according to preset child application template code and a serving party attribute corresponding to the selected child application identification information.

In an embodiment, the page code corresponding to the selected child application identification information includes code used for accessing a plug-in. The computer readable instructions further cause the processor to perform: obtaining a corresponding plug-in according to the code used for accessing a plug-in; and the drawing a selected public component, to form a corresponding child application page includes: drawing the selected public component and the obtained plug-in, to form the corresponding child application page.

After obtaining the target geographical location, the foregoing computer device may find child application identification information whose associated geographical location is close to the target geographical location, select the child application identification information therefrom, and run a corresponding child application in the environment provided by the mother application. Therefore, the needed child application may be determined by using the geographical location. This is convenient and fast; and the child application is run in the environment provided by the mother application for running the child application, without the need of a complex installation process, thereby improving the application use efficiency.

In an embodiment, one or more non-volatile computer readable storage media storing computer readable instructions are provided. The computer readable instructions, when executed by the one or more processors, cause the one or more processors to perform the following steps: obtaining a target geographical location; querying child application identification information that meets a geographical location proximity condition between associated geographical locations and the target geographical location; selecting child application identification information from the found child application identification information; and running a child application corresponding to the selected child application identification information in an environment provided by a mother application for running child applications.

In an embodiment, obtaining a target geographical location includes: obtaining a current geographical location as the target geographical location; or obtaining a character input in a search box, and obtaining, according to the input character, the target geographical location obtained by analyzing the input character; or obtaining a geographical location associated with local child application identification information as the target geographical location.

In an embodiment, the geographical location proximity condition includes: the geographical locations associated with the found child application identification information fall within a geographical region range to which the target geographical location belongs; or the target geographical location falls within a geographical region range to which the geographical locations associated with the found child application identification information belong; or a geographical region range to which the geographical locations associated with the found child application identification information belong and a geographical region range to which the target geographical location belongs have an intersection.

In an embodiment, selecting child application identification information from the found child application identification information includes: entering an identification information display page; displaying the found child application identification information in the identification information display page; obtaining a child application selection instruction acting on the identification information display page; and selecting child application identification information specified by the child application selection instruction from the displayed child application identification information.

In an embodiment, before the entering an identification information display page, the computer readable instructions further cause the processor to perform the following steps: displaying an entry used for triggering the identification information display page; displaying icons included in a preset number of pieces of child application identification information in the found child application identification information at the entry, and/or displaying a total number of pieces of the found child application identification information at the entry; and performing the step of entering an identification information display page, when detecting a trigger operation for the entry.

In an embodiment, selecting child application identification information from the found child application identification information includes: sorting the found child application identification information according to geographical distances between the associated geographical locations and the target geographical location; displaying the sorted child application identification information; and selecting the child application identification information from the displayed sorted child application identification information.

In an embodiment, sorting the found child application identification information according to geographical distances between the associated geographical locations and the target geographical location includes: obtaining the geographical distances between the geographical locations associated with the found child application identification information and the target geographical location; obtaining score reference attributes related to child applications corresponding to the found child application identification information; obtaining, according to the geographical distances and the score reference attributes, score values corresponding to the found child application identification information; and sorting the found child application identification information according to the corresponding score values.

In an embodiment, the score reference attributes include one of or a combination of more of the following: access statistics of a corresponding child application, a child application category, access statistics of a corresponding function component, use statistics of a corresponding function component, a related user attribute, a related user relationship link attribute, a related user feedback quantization value, related time information, and a grading level of a geographical region range to which the associated geographical locations belong.

In an embodiment, selecting child application identification information from the found child application identification information includes: when a plurality of pieces of the found child application identification information corresponds to the same serving party identification information, displaying the corresponding serving party identification information; obtaining a serving party selection instruction acting on the displayed serving party identification information; displaying child application identification information corresponding to serving party identification information specified by the serving party selection instruction; and selecting child application identification information from the displayed child application identification information.

In an embodiment, the geographical locations associated with the child application identification information are entered after log in with a public identifier, and are associated with child application identification information specified by the public identifier.

In an embodiment, running a child application corresponding to the selected child application identification information in an environment provided by a mother application for running child applications includes: obtaining page code corresponding to the selected child application identification information; selecting, according to the page code, a public component from a public component library provided by the mother application; and drawing the selected public component, to form a corresponding child application page.

In an embodiment, the page code corresponding to the selected child application identification information is generated according to preset child application template code and a serving party attribute corresponding to the selected child application identification information.

In an embodiment, the page code corresponding to the selected child application identification information includes code used for accessing a plug-in. The computer readable instructions further cause the processor to perform: obtaining a corresponding plug-in according to the code used for accessing a plug-in; and the drawing a selected public component, to form a corresponding child application page includes: drawing the selected public component and the obtained plug-in, to form the corresponding child application page.

After obtaining the target geographical location, the foregoing storage medium may find child application identification information whose associated geographical location is close to the target geographical location, select the child application identification information therefrom, and run a corresponding child application in the environment provided by the mother application. Therefore, the needed child application may be determined by using the geographical location. This is convenient and fast; and the child application is run in the environment provided by the mother application for running the child application, without the need of a complex installation process, thereby improving the application use efficiency.

It should be understood that although the steps in the embodiments of this application are not necessarily performed in an order indicated by the step numbers. Unless explicitly stated in this specification, the execution of these steps is not strictly sequential, and these steps may be executed in another sequence. Moreover, at least some of the steps in each embodiment may include a plurality of sub-steps or stages, which may not necessarily be completed at the same moment, but may be performed at different moments. These sub-steps or stages are not necessarily performed in sequence, but may be performed in turn or alternately with at least some of other steps or sub-steps or stages of the other steps.

A person of ordinary skill in the art may understand that all or some of the processes of the methods in the foregoing embodiments may be implemented by a computer program instructing relevant hardware. The program may be stored in a non-volatile computer-readable storage medium. When the program is run, the processes of the foregoing methods in the embodiments may be included. Any reference to a memory, a storage, a database, or other media used in the embodiments provided in this application may include a non-volatile and/or a volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache. By way of description rather than limitation, the RAM may be obtained in a plurality of forms, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM), a rambus direct RAM (RDRAM), a direct rambus dynamic RAM (DRDRAM), and a rambus dynamic RAM (RDRAM).

The technical features of the foregoing embodiments may be randomly combined. For the purpose of concise descriptions, not all possible combinations of the technical features in the foregoing embodiments are described, but as long as combinations of the technical features do not conflict each other, the combinations of the technical features should be considered as falling within the scope of this specification.

The foregoing embodiments only describe several implementations of this application, which are described specifically and in detail, and therefore cannot be construed as a limitation to the patent scope of the present invention. It should be noted that various changes and improvements may further be made by a person of ordinary skill in the art without departing from the idea of this application, and these changes and improvements all fall within the protection scope of this application. Therefore, the protection scope of this application shall be subject to the appended claims.

What is claimed is:

1. An application processing method, comprising:
obtaining, by a computer device, a target geographical location;
querying, by the computer device, for found child application identification information that meets a geographical location proximity condition between associated geographical locations of the found child application identification information and the target geographical location;
selecting, by the computer device, selected child application identification information from the found child application identification information; and
running, by the computer device, a child application corresponding to the selected child application identification information in an environment provided by a mother application for running child applications.

2. The method according to claim 1, wherein the obtaining, by a computer device, a target geographical location comprises at least one of:
obtaining, by the computer device, a current geographical location as the target geographical location;
obtaining, by the computer device, a character input in a search box, and obtaining, according to the input character, the target geographical location obtained by analyzing the input character; or
obtaining, by the computer device, a geographical location associated with local child application identification information as the target geographical location.

3. The method according to claim 1, wherein the geographical location proximity condition comprises at least one of:
geographical locations associated with the found child application identification information fall within a geographical region range to which the target geographical location belongs;
the target geographical location falls within a geographical region range to which the geographical locations associated with the found child application identification information belong; or
a geographical region range to which the geographical locations associated with the found child application identification information belong and a geographical region range to which the target geographical location belongs have an intersection.

4. The method according to claim 1, wherein the selecting, by the computer device, the selected child application identification information from the found child application identification information comprises:
entering, by the computer device, an identification information display page;
displaying, by the computer device, the found child application identification information in the identification information display page;
obtaining, by the computer device, a child application selection instruction acting on the identification information display page; and
selecting, by the computer device, the selected child application identification information specified by the child application selection instruction from the displayed found child application identification information.

5. The method according to claim 4, further comprising:
displaying, by the computer device, an entry used for triggering the identification information display page;
displaying, by the computer device, icons comprised in at least one of a preset number of pieces of child application identification information in the found child application identification information or a total number of pieces of the found child application identification information, at the entry; and
performing, by the computer device, entering an identification information display page in response to detecting a trigger operation for the entry.

6. The method according to claim 1, wherein selecting, by the computer device, the selected child application identification information from the found child application identification information comprises:
sorting, by the computer device, the found child application identification information according to geographical distances between the associated geographical locations and the target geographical location;
displaying, by the computer device, the sorted found child application identification information; and
selecting, by the computer device, the selected child application identification information from the displayed sorted child application identification information.

7. The method according to claim 6, wherein sorting, by the computer device, the found child application identification information according to geographical di stances between the associated geographical locations and the target geographical location comprises:
obtaining, by the computer device, the geographical distances between the geographical locations associated with the found child application identification information and the target geographical location;
obtaining, by the computer device, score reference attributes related to child applications corresponding to the found child application identification information;
obtaining, by the computer device, according to the geographical distances and the score reference attributes, score values corresponding to the found child application identification information; and
sorting, by the computer device, the found child application identification information according to the corresponding score values.

8. The method according to claim 1, wherein the geographical locations associated with the found child application identification information are entered after log in with a public identifier, and are associated with child application identification information specified by the public identifier.

9. The method according to claim 1, wherein running, by the computer device, the child application corresponding to the selected child application identification information in an environment provided by the mother application for running child applications comprises:
obtaining, by the computer device, page code corresponding to the selected child application identification information;
selecting, by the computer device according to the page code, a public component from a public component library provided by the mother application; and
drawing, by the computer device, the selected public component, to form a corresponding child application page.

10. The method according to claim 9, wherein the page code corresponding to the selected child application identification information is generated according to preset child application template code and a serving party attribute corresponding to the selected child application identification information.

11. The method according to claim 9, wherein the page code corresponding to the selected child application identification information comprises code used for accessing a plug-in;
wherein the method further comprises:
obtaining, by the computer device, a corresponding plug-in according to the code used for accessing a plug-in; and
wherein drawing, by the computer device, the selected public component, to form the corresponding child application page comprises:
drawing, by the computer device, the selected public component and the obtained plug-in, to form the corresponding child application page.

12. A computer device, comprising a memory and one or more processors, the memory storing computer readable instructions, and the computer readable instructions, when executed by the one or more processors, causing the one or more processors to perform the following:
obtaining a target geographical location;
querying for found child application identification information that meets a geographical location proximity condition between associated geographical locations and the target geographical location;
selecting selected child application identification information from the found child application identification information; and
running a child application corresponding to the selected child application identification information in an environment provided by a mother application for running child applications.

13. The computer device according to claim 12, wherein selecting the selected child application identification information from the found child application identification information comprises:
entering an identification information display page;
displaying the found child application identification information in the identification information display page;
obtaining a child application selection instruction acting on the identification information display page; and
selecting the selected child application identification information specified by the child application selection instruction from the displayed found child application identification information.

14. The computer device according to claim 13, wherein the computer readable instructions further cause the one or more processors to perform the following:
displaying an entry used for triggering the identification information display page;
displaying, at the entry, icons comprised in at least one of a preset number of pieces of child application identification information in the found child application identification information or a total number of pieces of the found child application identification information; and
entering an identification information display page in response to detecting a trigger operation for the entry.

15. The computer device according to claim 12, wherein selecting the selected child application identification information from the found child application identification information comprises:
sorting the found child application identification information according to geographical distances between the associated geographical locations and the target geographical location;
displaying the sorted found child application identification information; and
selecting the selected child application identification information from the displayed sorted child application identification information.

16. The computer device according to claim 15, wherein sorting the found child application identification information according to geographical distances between the associated geographical locations and the target geographical location comprises:
obtaining the geographical distances between the geographical locations associated with the found child application identification information and the target geographical location;
obtaining score reference attributes related to child applications corresponding to the found child application identification information;
obtaining, according to the geographical distances and the score reference attributes, score values corresponding to the found child application identification information; and
sorting the found child application identification information according to the corresponding score values.

17. The computer device according to claim 12, wherein running the child application corresponding to the selected child application identification information in the environment provided by the mother application for running child applications comprises:
obtaining page code corresponding to the selected child application identification information;
selecting, according to the page code, a public component from a public component library provided by the mother application; and
drawing a selected public component, to form a corresponding child application page.

18. The computer device according to claim 17, wherein the page code corresponding to the selected child application identification information is generated according to preset child application template code and a serving party attribute corresponding to the selected child application identification information.

19. The computer device according to claim 17, wherein the page code corresponding to the selected child application identification information comprises code used for accessing a plug-in;
wherein the computer readable instructions further cause the one or more processors to perform the following:
obtaining a corresponding plug-in according to the code used for accessing a plug-in; and
wherein drawing the selected public component, to form the corresponding child application page comprises:
drawing the selected public component and the obtained plug-in, to form the corresponding child application page.

20. One or more non-volatile computer readable storage mediums storing computer readable instructions, the computer readable instructions, when executed by one or more processors, cause the one or more processors to perform the following:
obtaining a target geographical location;
querying for found child application identification information that meets a geographical location proximity condition between associated geographical locations and the target geographical location;
selecting selected child application identification information from the found child application identification information; and
running a child application corresponding to the selected child application identification information in an environment provided by a mother application for running child applications.
